(19) United States
(12) Patent Application Publication
(10) Pub. No.: US 2021/0331149 A1
(43) Pub. Date: Oct. 28, 2021

(54) BIOCHAR-MODIFIED BISMUTH VANADATE CATALYST AND PREPARATION METHOD AND USE THEREOF

(71) Applicant: Chengdu University of Information Technology, Chengdu (CN)

(72) Inventors: Xueqiao ZHANG, Chengdu (CN); Mengyuan GUO, Chengdu (CN); Hongyuan XIANG, Chengdu (CN)

(21) Appl. No.: 17/151,364

(22) Filed: Jan. 18, 2021

(30) Foreign Application Priority Data
Apr. 27, 2020 (CN) 202010342069.8

(51) Int. Cl. B01J 37/03; B01J 37/04; B01J 37/08; B01J 23/22

(52) U.S. Cl. CPC B01J 37/031; B01J 23/22; B01J 37/08; B01J 37/04

(57) ABSTRACT

A biochar-modified bismuth vanadate catalyst and a preparation method thereof, and a method for treating sulfonamide containing waste water are disclosed. The method for preparing the biochar-modified bismuth vanadate catalyst comprises preparation of a biochar: converting a walnut shell into a walnut shell biochar; preparation of a biochar-modified bismuth vanadate catalyst: dissolving a certain amount of P123 completely in concentrated nitric acid, adding ethanol, adding Bi(NO₃)₃.5H₂O and NH₄VO₃ while vigorously stirring, adding a biochar, adjusting the pH value, stirring for 0.5-2 hours, and then transferring the mixture to an autoclave, heating to 120° C. in a blast drying box and maintaining at the temperature for 12 hours, and naturally cooling to ambient temperature, to obtain a yellow precipitate, washing and dried the yellow precipitate, to obtain a biochar-modified bismuth vanadate catalyst.

### CROSS REFERENCE TO RELATED APPLICATION

The application claims priority to Chinese patent application No. 202010342069.8, filed on Apr. 27, 2020, entitled “biochar-modified bismuth vanadate catalyst and preparation method and use thereof”, which is hereby incorporated by reference in its entirety.

### TECHNICAL FIELD

The present disclosure relates to a technical field of a catalyst, a preparation method and a use thereof, and particularly to a biochar-modified bismuth vanadate catalyst and a preparation method thereof, and its use in treating sulfanilamide containing waste water.

### BACKGROUND

With the development of social economy, environmental pollution has become one of the biggest threats facing human beings. Excessive consumption of fossil fuels and the discharge of toxic chemical substances have led to global warming and water pollution, raising great challenges for human survival. In particular, the rapid development of industrialization has caused a large number of pollutants such as dyes, heavy metals, pesticides and surfactants to be discharged, which has adversely affected the ecological environment and the survival of species. Only by using effective methods to reduce pollution source discharge and to treat pollutant, can mankind restrain the continuous worsening of environmental and water source pollution.

With the continuous advancing of water pollution treatment technology, photocatalytic technology based on advanced oxidation technology has gradually become a research hotspot in water pollution treatment. Photocatalytic technology has the characteristics of environmental friendliness, economic feasibility, simple for operation and no secondary pollution, and has been payed more and more attention in the fields of energy and environment. Since Japanese scientists Fujishima and Honda discovered in 1972 that a single crystal titanium dioxide (TiO₂) electrode can be used to photolyze water when exposed to light to produce hydrogen (H₂), there has been a rapid development in photocatalytic technology. TiO₂ has quickly become a research hotspot in the field of photocatalysis due to its advantages such as low price, non-toxicity and stability. However, because of the wide band gap of TiO₂ (Eg of about 3.2 eV), TiO₂ can only be excited by ultraviolet light, which accounts for only about 5% of the solar spectrum, while cannot be excited by visible light, whose energy accounts for most of the solar energy (45%), resulting in a low utilization rate of sunlight. Therefore, it is imperative to develop a new photocatalyst with a narrower band gap that can absorb the visible light part of the solar energy.

Since Kudo firstly reported in 1998 that BiVO₄ was used to decompose water when exposed to visible light in a AgNO₃ solution to produce O₂, BiVO₄, as a good visible-light excited photocatalyst, has attracted the attention of scholars. BiVO₄ is widely used in the photocatalytic degradation of organic pollutants in water due to its advantages such as non-toxicity, low band-gap energy, and corrosion resistance and is a promising photocatalyst. However, during the research process, it has been found that BiVO₄ has serious defects—its small specific surface area and rapid recombination of photo-generated carriers in the bulk, which lead to a very low quantum yield. In order to overcome the defects, scholars have explored many approaches, such as morphology control, element doping, semiconductor composite materials and carbon composite materials. Among them, the composite materials of BiVO₄ with carbon have attracted more and more attention, in which carbon can act as a bridge for electron transfer, thereby reducing the recombination rate of photo-generated electrons and holes during the photocatalytic process. In addition, carbon has a large specific surface area, which makes it possible to effectively adsorb pollutants, thereby improving photocatalytic efficiency. Commonly used carbons such as activated carbon, graphene, C₆₀, C₇₀, have a limited application due to their high prices. Therefore, it is hoped to develop cheap and easily available carbon. Biochar is prepared from biomass, with a wide variety of raw materials and low prices, and contains abundant functional groups on the biochar surface, which is beneficial to adsorbing pollutants.

In summary, the current problems are as follows:

1. BiVO₄ has a small specific surface area, resulting in fewer active sites and poor activity during the photocatalytic reaction;

2. BiVO₄ has a high recombination probability of photo-generated charge and a short photo-generated carrier lifetime, resulting in a poor photocatalytic activity;

3. BiVO₄ can be excited by a narrow range of visible light;

4. Commonly used carbons such as activated carbon, graphene, C₆₀, C₇₀, have limited application due to their high prices.

### SUMMARY

One of the objectives of the present disclosure is to provide a method for preparing a biochar-modified bismuth vanadate catalyst, with a widely available raw material and a great photocatalytic ability.

The above objective could be achieved by the following technical solutions:

A method for preparing a biochar-modified bismuth vanadate catalyst, comprising:

preparation of a biochar
washing a walnut shell with deionized water, drying the walnut shell to remove water on the surface of the walnut shell, crushing and sieving the dried walnut shell to obtain walnut shell powder, immersing the walnut shell powder in a ZnCl₂ solution with a concentration of 1-3 mol/L for 24 hours, and removing a supernatant to obtain a remaining solid, drying the remaining solid in an oven at 105° C. for 24 hours to obtain a dried remaining solid; heating the dried remaining solid in a tube furnace under a nitrogen atmosphere to 300-800° C. at a rate of 5-10° C./min, controlling the temperature to be constant, starting counting the time, subjecting the dried remaining solid to a pyrolysis for 3 hours, stopping the heating, to obtain a pyrolysis solid product; cooling the pyrolysis solid product to ambient temperature, taking the cooled pyrolysis solid product out of the tube furnace, crushing and sieving the cooled pyrolysis solid product, to obtain pyrolysis solid product powder, mixing the pyrolysis solid product powder with an enough HNO₃ solution with a concentration of 0.5-1.5 mol/L to obtain a mixture, supersonically dispersing the mixture for 30 minutes, centrifuging the resulting mixture, to obtain a crude solid product, washing the crude solid product with deionized water until the obtained washing liquid is neutral; finally, completely drying the crude solid product in a blast drying box at 60-90° C., to obtain a walnut-shell biochar; and

preparation of biochar-modified bismuth vanadate catalyst
dissolving a certain amount of P123 in concentrated nitric acid, adding ethanol with a volume of 10-30 times the volume of the added concentrated nitric acid, adding Bi(NO₃)₃.5H₂O while vigorously stirring, in such an amount that a molar ratio of bismuth vanadate to P123 in the biochar-modified bismuth vanadate catalyst is in a range of 1:0.01-0.05, adding NH₄VO₃ in an amount equimolar with that of Bi(NO₃)₃.5H₂O while vigorously stirring, to form a yellow precipitate, thereby obtaining a suspension, adding the walnut-shell biochar to the suspension, and adjusting a pH value of the resulting mixture to 7 with NaOH and HNO₃; and stirring the resulting mixture for 0.5-2 hours, and transferring the resulting mixture to a tetrafluoroethylene-lined stainless steel autoclave, keeping a total volume of the resulting mixture in the tetrafluoroethylene-lined stainless steel autoclave not less than ⅔ of the capacity of the autoclave, otherwise adding ethanol, placing the tetrafluoroethylene-lined stainless steel autoclave in a blast drying box, heating to 120° C. and maintaining at the temperature for 12 hours therein; cooling to ambient temperature naturally to obtain a yellow precipitate, washing the yellow precipitate with ethanol by centrifugation for 3-5 times, then washing with deionized water by centrifugation for 3-5 times, drying the precipitate in a blast drying box at 80° C. for 12 hours, to obtain the biochar-modified bismuth vanadate catalyst.

In some embodiments, drying the walnut shell to remove water on the surface of the walnut shell comprises drying the walnut shell in an oven at 60-90° C. for 0.5-1 hour.

In some embodiments, crushing and sieving the dried walnut shell to obtain walnut shell powder comprises sieving the dried walnut shell with a 100-mesh sieve.

In some embodiments, completely drying the crude solid product in a blast drying oven at 60-90° C. comprises drying the crude solid product for 2-5 hours.

According to the present disclosure, since the walnut shell is essentially composed of lignocellulose, it is possible to gradually depolymerize macromolecules by an immersion, a hydrolysis, and a oxidation in a ZnCl₂ solution so that micropores are formed in the raw material. The pyrolysis is to subject the lignocellulose after hydrolysis and oxidation to a pyrolysis in an oxygen-free atmosphere, thereby converting macromolecular polymers to carbon-containing small molecules, and forming an intricate porous structure because of changes in amorphous carbon structure. The temperature is generally increased at a rate of 5-10° C./min; because cellulose and hemicellulose gradually begin to decompose at a temperature below 450° C., which is a process reaction, the temperature may not be increased too quickly to ensure complete decomposition of the components. In the process of crushing and sieving of the walnut-shell biochar product, because the walnut shells after pyrolysis would agglomerate, a further sieving is required to ensure the biochar particles (in the pyrolysis product powder) with the same particle size. Treating the biochar with HNO₃ is firstly to pickle away the ash impurities on the surface after calcination, leaving behind carbon structure containing substances; and secondly to increase the surface functional groups of biochar by chemical reactions, thereby improving the adsorption of biochar to sulfonamide, the molecule to be decomposed. The drying after the pyrolysis is to ensure that the biochar is completely dry before being used to prepare the photocatalyst. The judgment is made by considering whether the biochar particles are dispersed and not adhered to each other, and the drying is performed generally for 2-5 hours.

According to the present disclosure, P123 is used as a template, mainly to control the order of bismuth vanadate crystal grain arrangement. Concentrated nitric acid (with a concentration of 65-68 wt %) is firstly to dissolve P123, and secondly to inhibit the hydrolysis of Bi(NO₃)₃.5H₂O, as Bi(NO₃)₃.5H₂O would hydrolyze to generate precipitation. Ethanol is to make Bi′ chelate with hydroxyl (.OH), to disperse BiVO₄ through the steric hindrance effect, thereby avoiding the agglomeration of BiVO₄. There is no special limitation to the stirring rate of the vigorous stirring, generally to ensure that the mixed solution can be completely stirred. The pH value directly affects the morphology of BiVO₄, so the pH value shall be strictly controlled; the pH value in one embodiment is adjusted to about 7 (as measured with precision test paper). The volume of the solution not less than ⅔ of the capacity of the autoclave is to ensure an upper space with a certain volume in the autoclave, to form a certain pressure during the hydrothermal process, thereby ensuring that the bismuth vanadate grains grow in an orderly arrangement and with a well-crystallized form. The centrifuging and washing is to remove free Bi′ and excess biochar.

The present disclosure further provides a biochar-modified bismuth vanadate catalyst, as prepared by the method for preparing a biochar-modified bismuth vanadate catalyst.

The present disclosure further provides a use of a biochar-modified bismuth vanadate catalyst for treating sulfonamide containing waste water.

In some embodiments, under the condition that the biochar-modified bismuth vanadate catalyst is used to treat sulfonamide containing waste water, the biochar-modified bismuth vanadate catalyst is used in an amount of 50-100 times the mass of sulfonamide contained in the sulfonamide containing waste water.

In some embodiments, under the condition that the biochar-modified bismuth vanadate catalyst is used to treat sulfonamide containing waste water, H₂O₂ is added simultaneously when adding the biochar-modified bismuth vanadate catalyst, in an amount which accounts for 1% of the volume of sulfonamide containing waste water, meanwhile the resulting solution is maintained acidic or neutral, stirred for 30 minutes in the dark to be uniform, and exposed to natural light for 7 hours.

It should be noted that the present disclosure is directed to sulfonamide containing waste water, which is waste water after conventional physico-chemical-biological treatment technology, in which sulfonamide is the main harmful substance. Therefore, the present disclosure is directed to an advanced treatment of sulfonamide containing waste water, and one of its purposes is to eliminate sulfonamide contained in the sulfonamide containing waste water, with a removal rate generally over 97%.

In some embodiments of the present disclosure, the biochar has a large specific surface area; the specific surface area of bismuth vanadate is greatly increased by the dopping of BiVO₄ in the biochar. In addition, biochar is one of the substances that have extremely high conductivity, and the photoelectron produced by BiVO₄ can be captured by biochar, thereby reducing the probability of the recombination of photoelectrons and holes, and thereby greatly increasing the visible-light utilization efficiency of BiVO₄. Biomass materials, which are used to prepare biochar, are widely available and low-priced. Biochar is widely used as an adsorbent, while little researched as a photocatalyst, especially a photocatalyst for the degradation of sulfonamide containing waste water. The biochar-modified bismuth vanadate catalyst according to the present disclosure is low-priced and more uniform in particle size, and makes it possible to effectively degrade the sulfonamide contained in the sulfonamide containing waste water, with a great practical value.

### BRIEF DESCRIPTION OF THE DRAWINGS

FIGS. 1 and 2 show X-ray diffraction (XRD) patterns of composite materials of BiVO₄ with carbon (referred as CBi composite materials) as prepared in an example of the present disclosure.

FIG. 3 shows a scanning electron microscope (SEM) image of (a) C-700, (b) BiVO₄ (CBi-0%), (c) CBi-700 (CBi-20%) (×50K), and (d) CBi-700 (CBi-20%) (×100K), high-resolution transmission electron microscope (HTEM) images of (e) CBi-700 (CBi-20%) (121) crystal plane and (f) CBi-700 (CBi-20%) (040) crystal plane, and energy dispersive X-ray spectrum (EDS) diagram of (g) CBi-700 (CBi-20%);

FIG. 4 shows X-ray photoelectron spectra (XPS) images of the CBi-700 (CBi-20%) sample, in which (a) represents survey, (b) represents an enlarged view of fitted O 1s peaks in (a), (c) represents an enlarged view of fitted Bi 4f peaks in (a), (d) represents an enlarged view of fitted V 2p peaks in (a), and (e) represents an enlarged view of fitted C 1s peaks in (a);

FIG. 5 shows Fourier transform infrared spectroscopy (FTIR) diagrams of biochar and CBi composite materials according to one embodiment of the present disclosure, in which (a) represents biochar, (b) represents CBi composite materials at different pyrolysis temperatures, and (c) represents CBi composite materials with different loading amounts;

FIG. 6 shows UV-Vis diffuse reflectance spectra (UV-VIS-DRS) graphs of CBi composite materials according to one embodiment of the present disclosure, in which (a) shows absorbances of BiVO₄ and CBi composite materials at different pyrolysis temperatures, (b) shows energy band gap (Eg) of BiVO₄ and CBi composite materials at different pyrolysis temperatures, obtained by fitting a plot of (αhν)² versus hν, (c) shows absorbances of CBi composite materials with different loading amounts, and (d) shows energy band gap (Eg) of CBi composite materials with different loading amounts, obtained by fitting a plot of (αhν)² versus hν;

FIG. 7 shows photoluminescence spectra graphs of CBi composite materials according to one embodiment of the present disclosure, in which (a) shows fluorescence intensities of BiVO₄ and CBi composite materials at different pyrolysis temperatures, and (b) shows fluorescence intensities of CBi composite materials with different loading amounts;

FIG. 8 shows electrochemical impedance spectra diagram of CBi composite materials according to one embodiment of the present disclosure, and graphs illustrating variations of current with time when exposed to the light, in which (a) shows EIS Nyquist plots of the electrochemical impedance spectra curves of CBi composite materials at different pyrolysis temperatures, (b) shows EIS Nyquist plots of the electrochemical impedance spectra curves of CBi composite materials with different loading amounts, (c) shows variations of photocurrent of CBi composite materials at different pyrolysis temperatures with time when exposed to the light, (d) shows variations of photocurrent of CBi composite materials with different loading amounts with time when exposed to the light;

FIG. 9 shows visible light catalyzed degradation of sulfonamide and repeated experiments of CBi-700-20% used to treat sulfonamide, in which (a) represents using BiVO₄ and CBi composite materials at different pyrolysis temperatures as catalysts, (b) represents using CBi composite materials with different loading amounts as catalysts, and (c) represents repeated experiments when using CBi-700-20% as catalyst;

FIG. 10 shows effects of pH, the amount of oxidant, and the amount of catalyst on the photocatalytic degradation of sulfonamide containing waste water, in which (a) shows effects of amount of oxidant on the removal rate, (b) shows effects of pH value on the removal rate, and (c) shows effects of amount of catalyst on the removal rate.

### DETAILED DESCRIPTION OF THE EMBODIMENTS

The present disclosure will be further described below in conjunction with the figures and specific embodiments.

A method is used to prepare a biochar-modified bismuth vanadate catalyst, comprising:

preparation of a biochar
a walnut shell was washed with deionized water, and dried in a oven at 85° C.; the dried walnut shell was crushed and sieved through a 100-mesh sieve, to obtain walnut shell powder; the walnut shell powder was immersed in a 2 mol/L ZnCl₂ solution for 24 hours; a supernatant was removed, to obtain a remaining solid, and the remaining solid was completely dried in an oven at 105° C., to obtain a dried remaining solid; the dried remaining solid was subjected to a pyrolysis at 300° C., 500° C., 700° C., 800° C. (to which the temperature was increased at a rate of 5° C./min) under a nitrogen atmosphere in a tube furnace for 3 hours; the tube furnace was cooled to ambient temperature, to obtain a cooled pyrolysis solid product; the cooled pyrolysis solid product was crushed again by a crusher, and sieved through a 100-mesh sieve, to obtain pyrolysis solid product powder; the pyrolysis solid product powder was poured into 1 mol/L HNO₃ solution to obtain a mixture; the mixture was supersonically dispersed for 30 minutes, and centrifuged to obtain a crude solid product; the crude solid product was washed with deionized water until the obtained washing liquid was neutral; finally, the crude solid product was completely dried at 80° C. in a blast drying box, to obtain walnut-shell biochars, labeled as C-300, C-500, C-700, and C-800; and
preparation of CBi composite materials
   (1) preparation of photocatalysts from biochars obtained at different pyrolysis temperatures CBi composite materials were synthesized by simple hydrothermal method. Firstly, 0.00051 mol of P123 (purchased from Chengdu Kelong Chemical Reagents Factory) was dissolved in concentrated nitric acid (with a concentration of 65-68 wt %), then 120 mL of ethanol was added, 0.015 mol of Bi(NO₃)₃.5H₂O was added while vigorously stirring, to be completely dissolved, then 0.015 mol of NH₄VO₃ was added into the above mixture while vigorously stirring, then a yellow precipitate was formed in the system. Then, 0.972 g of biochar (C-300, C-500, C-700 and C-800, with a doping amount of 20%) obtained at different pyrolysis temperatures were added to the suspension system. On this basis, 1.0 mol/L NaOH solution was added to adjust the pH value of the system to 7. The resulting solution was stirred for 1 hour, then transferred to a 200 mL tetrafluoroethylene lined stainless steel autoclave (the filling rate was kept at 80%, otherwise less than 80%, ethanol is added), and then the tetrafluoroethylene lined stainless steel autoclave was heated to 120° C. in a blast drying box and kept at the temperature for 12 hours, then naturally cooled to ambient temperature, to obtain a yellow precipitate; the obtained yellow precipitate was washed with ethanol by centrifugation for 3 times, then washed with deionized water by centrifugation for 3 times. The washed solid was dried in a blast drying oven at 80° C. for 12 hours, obtaining biochar-modified bismuth vanadate catalyst samples, labeled as CBi-300, CBi-500, CBi-700, and CBi-800.

(2) Preparation of Photocatalysts with Different Loading Amounts

In this example, CBi composite materials synthesized by a simple hydrothermal method were used. Firstly, 0.00051 mol of P123 was dissolved in 5 mL of concentrated nitric acid (with a concentration of 65-68 wt %), then 120 mL of ethanol was added, then 0.015 mol of Bi(NO₃)₃.5H₂O was dissolved in the above solution while vigorously stirring, and then 0.015 mol of NH₄VO₃ was added while vigorously stirring, and a yellow precipitate was formed in the system. Then C-700 was added to the suspension system so that the mass percentages of C-700 to BiVO₄ were 0%, 5%, 10%, 20%, and 30% respectively, and the composite materials were prepared as described above. The obtained biochar-modified bismuth vanadate catalyst samples were labeled as CBi-0%, CBi-5%, CBi-10%, CBi-20%, and CBi-30% respectively.

This example also provides a use of the biochar-modified bismuth vanadate catalyst for treating sulfonamide containing waste water.

50 mg of the prepared materials were added into 50 mL of 15 mg/L sulfonamide (SA) solution, and 0.5 mL of H₂O₂ (1%) was added, without changing the pH value of the sample (pH=7), to obtain a mixture; the mixture was stirred in the photocatalytic reactor for 30 minutes in the dark to achieve an absorption-desorption equilibrium; a 350 W xenon lamp that generates visible light was turn on, the stirring was continued, a sampling was carried out every 1 h, and the samples were respectively filtered through 0.45 μm filter membrane to obtain a liquid sample, the concentration of sulfonamide in the liquid sample was measured with high performance liquid chromatography (HPLC).

The photocatalysts obtained in the above-mentioned example were subjected to relevant tests, and the results were shown as follows:

(1) BET and XRD

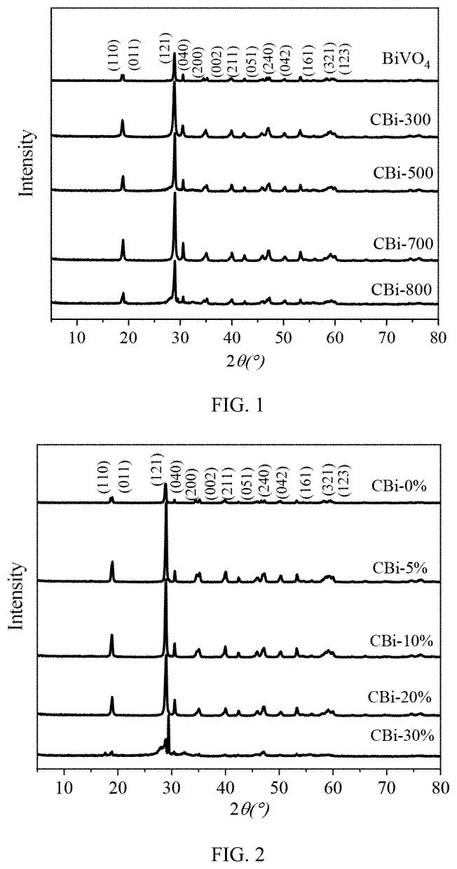

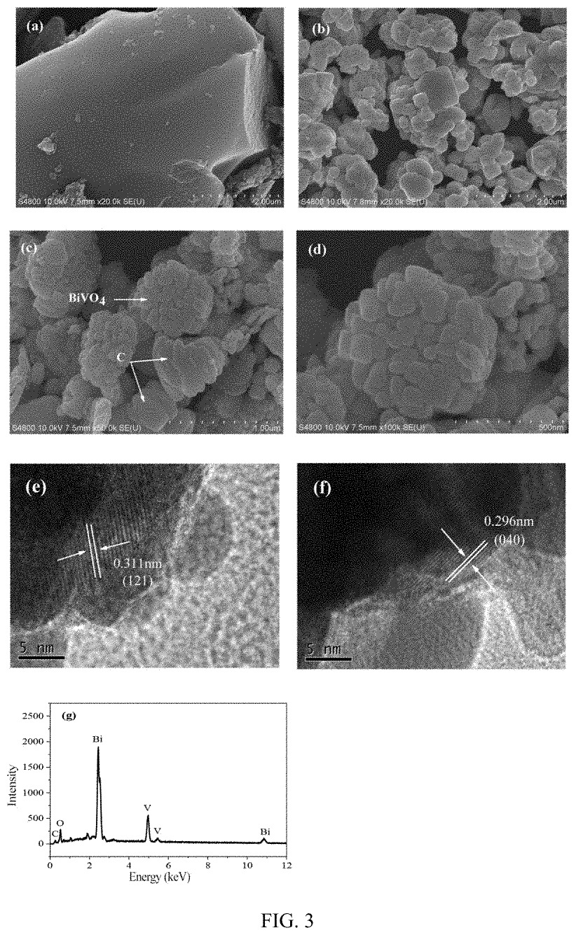

The BET results were shown in Table 1 and Table 2, the XRD spectra were shown in FIGS. 1 and 2, and the grain size and the peak intensity ratio of (040) to (121) were shown in Table 1 and Table 2.

Table 1. specific surface area, grain size, peak intensity ratio of (040) to (121), and band gap of photocatalysts at different pyrolysis temperatures

| | specific | | | |
|---|---|---|---|---|
| | surface | grain | | |
| | area | size | (040)/ | Eg |
| samples | m²/g | (nm) | (121) | (eV) |
| BiVO₄ | 2.51 | 30.04 | 0.17 | 2.40 |
| CBi-300 | 11.691 | 21.12 | 0.19 | 2.41 |
| CBi-500 | 63.924 | 30.04 | 0.17 | 2.41 |
| CBi-700 | 130.63 | 24 | 0.26 | 2.40 |
| CBi-800 | 124.93 | 20.18 | 0.14 | 2.32 |

TABLE 2
Specific surface area, grain size, peak intensity
ratio of (040) to (121), and band gap of
photocatalysts with different loading amounts

| | specific | | | |
|---|---|---|---|---|
| | surface | grain | | |
| | area | size | (040)/ | Eg |
| | m²/g | (nm) | (121) | (eV) |
| CBi-0% | 2.51 | 30.04 | 0.17 | 2.4 |
| CBi-5% | 31.87 | 30.15 | 0.14 | 2.45 |
| CBi-10% | 69.97 | 29.28 | 0.18 | 2.35 |
| CBi-20% | 130.63 | 24 | 0.26 | 2.4 |
| CBi-30% | 172.39 | 10.14 | 0.17 | 2.65 |

The specific surface area of the samples was measured by BET method, and it can be seen from Table 1 that the specific surface area of the sample was increased due to the presence of biochar, and the specific surface area of the CBi composite material was increased at first and decreased afterwards as the pyrolysis temperature was increased, and the specific surface area of CBi composite material was increased as the loading amount of the biochar was increased. Generally, larger specific surface area helps to provide more active centers for photocatalytic reaction, thereby improving the efficiency of the photocatalytic reaction. X-ray diffraction (XRD) analysis is to better understand the crystal structures of the prepared samples. It can be clearly seen from FIG. 1 that, except for the CBi-30% material, all the characteristic peaks of the CBi composite materials corresponded to those in the standard card of monoclinic scheelite (JCPDS 14-0688), and diffraction peaks of any impurities such as BiO₃ and V₂O₅, were not found, with sharp peaks, indicating that BiVO₄ prepared by the hydrothermal method in the present disclosure had high purity and good crystallinity. It is remarkable that no diffraction peaks of biochar were found in the figure, which may be because the biochar in the CBi composite material has an amorphous structure. It can be seen from Table 1 that the peak intensity ratio of (040) crystal plane to (121) crystal plane is respectively 0.17, 0.19, 0.17, 0.26, 0.14 (corresponding to BiVO₄, CBi-300, CBi-500, CBi-700, CBi-800 respectively) and 0.17, 0.14, 0.18, 0.26, 0.17 (corresponding to CBi-0%, CBi-5%, CBi-10%, CBi-20%, CBi-30% respectively). It was reported that the peak intensity ratio of (040) crystal plane to (121) crystal plane could reflect the degree of preferential exposure of (040) crystal plane, and the preferential exposure of (040) crystal plane helps to improve the photocatalytic activity of BiVO₄ materials. When biochars obtained at different pyrolysis temperatures and in different doping amounts were added, the (040) plane diffraction intensities of these CBi samples were obviously different. It can be seen that the pyrolysis temperature and loading amount have a direct effect on the preferential exposure degree of (040) crystal plane, the peak intensity ratio of (040) crystal plane to (121) crystal plane is maximum for CBi-700 and CBi-20%, indicating that the preparation conditions of pyrolysis temperature of 700° C. and loading amount of 20% are more conducive to improving the photocatalytic performance of the photocatalyst.

(2) SEM Test

As shown in FIG. 3, in which (a) and (b) are SEM images of C-700 and pure BiVO₄, respectively. It can be seen from FIG. 3 that C-700 is an amorphous block with a relatively smooth surface. The pure BiVO₄ sample exhibits an obvious stacking morphology, and the particle size of the stacked BiVO₄ ranges from 2-4 μm. (c) and (d) in FIG. 3 show SEM images of CBi-700 (CBi-20%) at different magnifications, which clearly shows that biochar and BiVO₄ are simultaneously present, and BiVO₄ particles are uniformly distributed on the surface of biochar, but also the BiVO₄ particles in the composite material are more uniform, finer, and nano-sized. It can be seen that the doping of biochar is beneficial to the adhesion and growth of BiVO₄ and uniform refinement of particles. (e) and (f) in FIG. 3 are TEM images of CBi-700-20%, with a lattice fringe width of 0.311 nm, which is consistent with (121) crystal plane spacing, so it corresponds to the (121) crystal plane; a crystal plane with a fringe width of 0.296 nm is attributed to (040) crystal plane. In addition, as shown in EDS spectrum of CBi-700 (CBi-20%) sample, only Bi, V, O, and C elements are present, indicating that the biochar has been successfully doped into BiVO₄.

(3) XPS Analysis

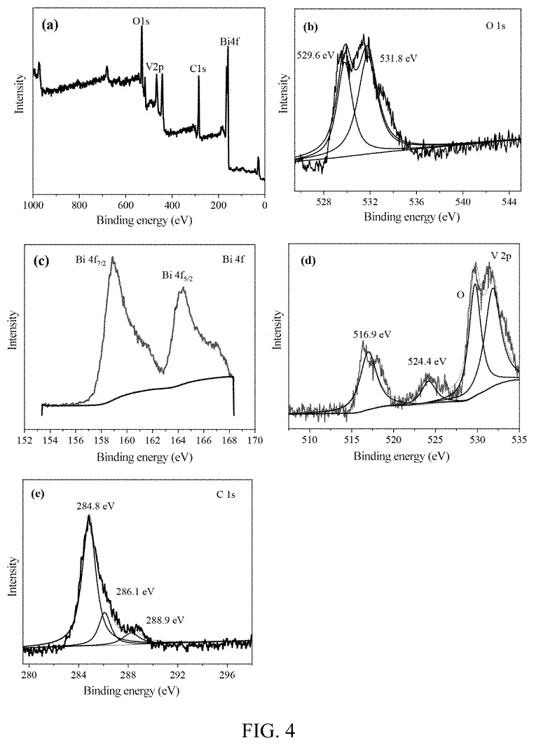

The element composition and electronic state of CBi-700 (CBi-20%) sample were analyzed by XPS. (a) in FIG. 4 shows a typical XPS measurement spectrum of CBi-700 (CBi-20%), in which peaks of Bi, V, C, and O elements can be clearly observed, which is consistent with the result of EDS. It can be seen that the biochar-modified BiVO₄ composite photocatalyst was successfully prepared by the hydrothermal method.

(b) in FIG. 4, for O 1s, the two oxygen species at binding energy values of 529.6 eV and 531.8 eV are respectively attributed to the lattice oxygen of Bi—O and the oxygen in the surface hydroxyl groups. In the Bi 4f spectrum of (c) in FIG. 4, the peaks at 164.4 eV and 158.9 eV correspond to Bi 4f_{5/2} and Bi 4f₇₁₂, both of which are attributed to Bi³⁺. For V 2p, the peaks at 516.9 eV and 524.2 eV may correspond to V 2p_{3/2} and V 2p_{1/2} respectively, which are attributed to V⁵⁺ in BiVO₄. Through peak separation and fitting of C 1s in (e) of FIG. 4, it can be found that there are three characteristic peaks at 284.8 eV, 286.1 eV and 288.9 eV, which are attributed to C═C, C—P, O—C═O, which are mainly caused by the doped biochar. It can be seen from the XPS spectroscopy results that BiVO₄ and biochar exhibit their respective binding states in the CBi composite material, and BiVO₄ has more functional groups after being doped with biochar, which is of great signification in the adsorption of reactive species and improvement of the photocatalytic degradation rate, which will be verified in subsequent degradation experiments.

(4) FTIR

The structure of modified BiVO₄ by biochar obtained at different pyrolysis temperatures and with different doping amounts was further studied by FTIR.

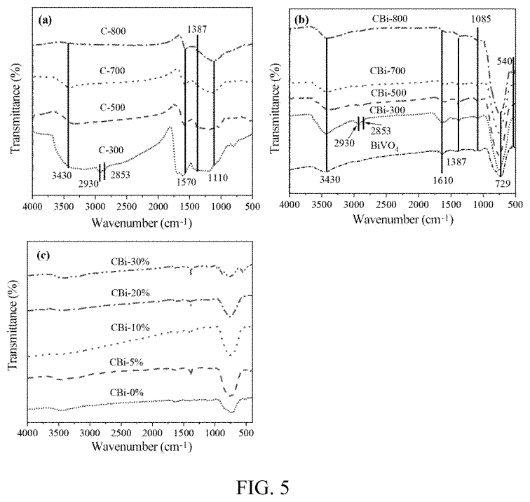

The FTIR spectrum of biochar is shown in (a) of FIG. 5, in which peaks at 3430 cm⁻¹ and 1110 cm⁻¹ are assigned to the stretching vibrations of O—H and C—O, respectively. The vibration peaks at 2930 cm⁻¹ and 2853 cm⁻¹ are assigned to the vibration of C—H. The peak at 1570 cm⁻¹ is assigned to the vibration of C═C, and the peak at 1387 cm⁻¹ is related to the vibration of —OH. As the pyrolysis temperature is increased, the O—H stretching motion at 3430 cm⁻¹ is gradually weakened, and the aliphatic C—H stretching vibration peaks at 2930 cm⁻¹ and 2953 cm⁻¹ disappear. (b) and (c) in FIG. 5 show FTIR spectra of CBi composite materials. It can be clearly seen that the CBi samples exhibit all the characteristic peaks of biochar. In addition, the peaks at 729 cm⁻¹ and 540 cm⁻¹ are assigned to the stretching vibrations of V-O and Bi—O, respectively. Obviously, after doping biochar, in addition to the vibration peaks of V-O and Bi—O, the vibration peaks at 1085 cm′, 1387 cm′, 1610 cm⁻¹ and 3430 cm⁻¹ still exist, that is to say, BiVO₄ after doping biochar further has C—O, —OH, C═C and O—H functional groups. It is reported that the presence of functional groups is beneficial to the adsorption of reactive molecules and can promote to increase the photocatalytic reaction rate.

(5) Ultraviolet Visible Diffuse Reflectance Spectrum (UV-Vis-DRS)

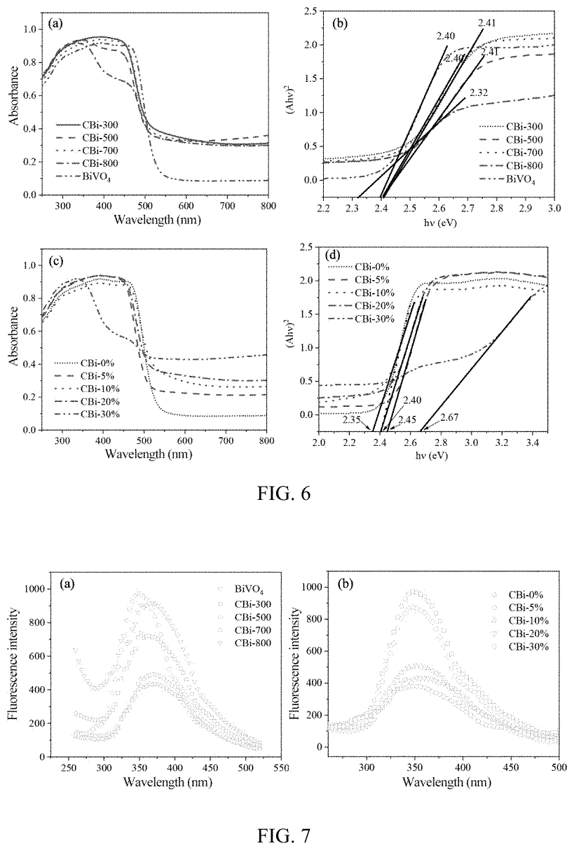

In order to further study the change of the band gap of the modified photocatalyst, two sets of catalysts were analyzed by UV-Vis-DRS. The results are shown in FIG. 6.

As shown in FIG. 6, compared with pure BiVO₄, the optical response range of the CBi material is expanded to 800 nm from 550 nm, indicating that the CBi composite material has an expanded response range in the visible light region due to the presence of biochar. The band gap energy (Eg) of a semiconductor can be calculated by the following formula:

αhν=A(hν−Eg)^{1/2}

Where α and ν represent the absorption coefficient of the semiconductor and optical frequency, respectively. By plotting (αhν)^{1/2} with hν, the band gap of the composite material is obtained. Table 1 summarizes Eg values of the CBi samples. The Eg value of the CBi sample is equivalent to the Eg value (2.39-2.51 eV) of the BiVO₄ material reported in the literature. Compared with other BiVO₄ samples, CBi-800 and CBi-10% have lower Eg values, indicating that CBi-800 and CBi-10% are more conducive to the utility of visible light compared with other catalysts. However, the photocatalytic reaction is a complex reaction process, which is not only affected by the band gap, but also by the separation efficiency and lifetime of electron-hole pairs. Therefore, it is necessary to further investigate the photoelectric performance of the catalyst.

(6) PL

Photoluminescence (PL) spectroscopy is a method commonly used to measure the separation efficiency of electron-hole pairs. In general, a lower PL spectrum intensity would lead to a higher separation efficiency of photogenerated carriers, thereby achieving a higher photocatalytic activity. It can be seen from FIG. 7 that the PL peak intensity is greatly reduced after introducing biochar into BiVO₄ material, indicating that biochar can promote e⁻/h⁺ separation. In addition, the pyrolysis temperature has a great influence on the luminescence properties of the CBi composite material. With the increase of the pyrolysis temperature, the fluorescence intensity of the CBi composite material decreases significantly. However, when the pyrolysis temperature exceeds 700° C., the fluorescence intensity increases instead. The results show that the separation efficiency of photogenerated electron-hole pairs in the CBi composite material are effectively improved by adding biochar at 700° C. (pyrolysis temperature), and a higher photocatalytic activity is achieved when the addition amount of C-700 is 20%. This result is consistent with the result of the photocatalytic performance test of the sample.

(7) Electrochemistry

In order to further prove the electrochemical characteristics of the CBi composite materials, the alternating-current impedance and photocurrent were analyzed on the electrochemical workstation. As all known, the radius of curvature in the electrochemical impedance spectroscopy (EIS) diagram can show the charge transfer efficiency of the electrode interface. A smaller radius of curvature would lead to a higher separation rate of photo-generated charge pairs.

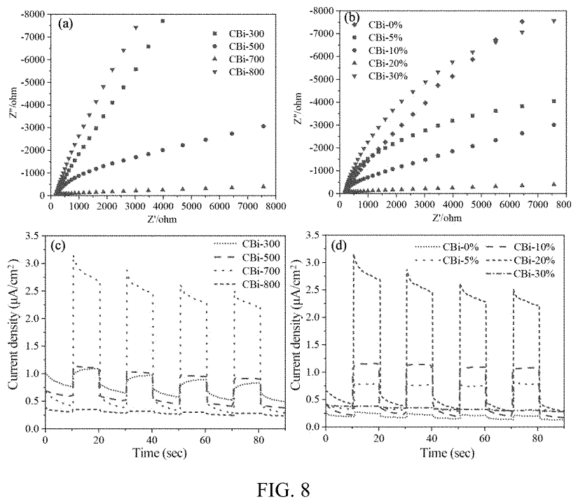

As shown in FIG. 8, the radiuses of curvature are sorted in the following order: CBi-700<CBi-500<CBi-300<CBi-800, which implies that the biochar generated by pyrolysis at 700° C. is more conducive to improving e⁻/h⁺ separation efficiency of the CBi-700 composite material surface. The doping amount of C-700 also affects the electrical properties of the composite material, and the electrical properties of the composite materials with different doping amounts are sorted in the following order: CBi-20%<CBi-10%<CBi-5%<CBi-30%<CBi-0%, which is consistent with the result of PL. In addition, during the exposure to visible light for 90 s, the transient photocurrent responses of CBi materials are shown in FIG. 8. In general, a larger photocurrent density would lead to a lower recombination rate of electrons and holes. Obviously, the conditions of pyrolysis temperature of 700° C. and loading amount of 20% are more conducive to improving the photoelectric performance of the photocatalyst, and reducing the recombination rate of electrons and holes. This result is consistent with the following result of photocatalytic activity test.

(8) Photocatalytic Properties

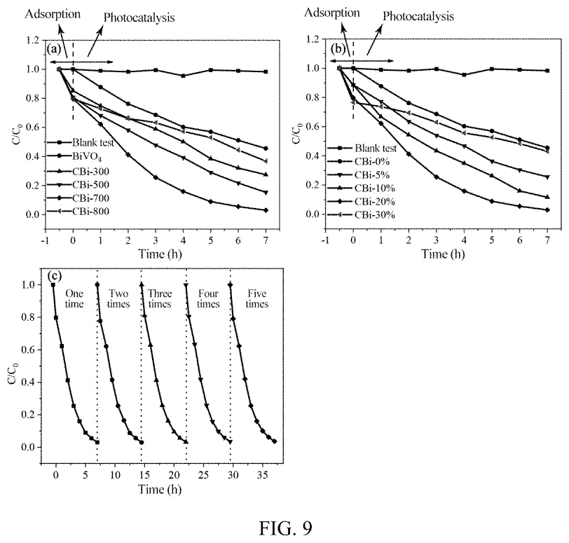

The photocatalytic activities of the CBi samples were evaluated by degrading SA. The results are shown in FIG. 9. When exposed to visible light, the degradation rate of SA is less than 2%, indicating that SA has great stability and the photolysis is very limited when directly exposed to light. After stirring for 30 minutes in the dark, CBi photocatalyst has a better adsorption performance than that of pure BiVO₄, indicating that the doping of biochar increases the specific surface area of the CBi material, thereby increasing the adsorption effect of SA. However, the adsorption rate of the CBi material to SA is less than 20.3%. It can be seen that the adsorption rate of the catalyst to SA is limited, and the degradation and removal of SA mainly results from the photocatalytic reaction. It can be seen from FIG. 9 that after the exposure to visible light for 7 hours, the maximum degradation rate of SA is 54.5% when using BiVO₄, while the degradation rate of SA when using the composite photocatalyst increases remarkably, and when the pyrolysis temperature is increased to 700° C. from 300° C., the degradation efficiency of SA increases significantly, while drops sharply when the pyrolysis temperature exceeds 800° C. The maximum degradation rate of SA when using CBi-700 may be 97% or larger. In addition, according to the photocatalytic activity results in terms of different loading amounts, the doping amount of C-700 also has a great effect on the photocatalytic activity. Among them, the optimal photocatalytic effect is achieved when using CBi-20%. It can be seen that the pyrolysis temperature of 700° C., and the loading amount of 20% is more conducive to improving the photocatalytic activity of the composite material. The results of photocatalytic activity test are consistent with that of PL test and electrochemical test. It can be seen that the separation efficiency and lifetime of photogenerated electrons pairs are the main factors determining photocatalytic activity, and the main reasons for the improvement of photocatalytic performance when using biochar doped BiVO₄ are as follows: on the one hand, the adsorption of the catalyst to SA is significantly improved by introducing functional groups and increasing the specific surface area of BiVO₄, thereby providing strong support for subsequent photocatalytic decomposition; on the other hand, biochar can capture electrons, which not only prevents the recombination of photogenerated electrons and holes, thereby extending lifetime of the photogenerated electron pair, but also accelerates the migration of photogenerated electrons to the catalyst surface, thereby promoting more oxidative radicals generated on the catalyst surface, and thereby increasing the degradation efficiency of SA.

It is necessary that the photocatalyst is stable when used in a practical application of the photocatalyst, so repeated experiments were carried out using CBi-700-20% composite photocatalyst. As shown in the figures, though CBi-700-20% is reused for 5 times under the same conditions, the photocatalytic degradation effect of SA only decreases by less than 1%. It can be seen that the composite photocatalyst prepared in the present disclosure under certain conditions not only makes it possible to achieve optimal degradation effect in terms of sulfonamide containing waste water, but also has great stability, which is of great significance to the recycle and reuse of the catalyst.

(9) Experiments Regarding Process Condition

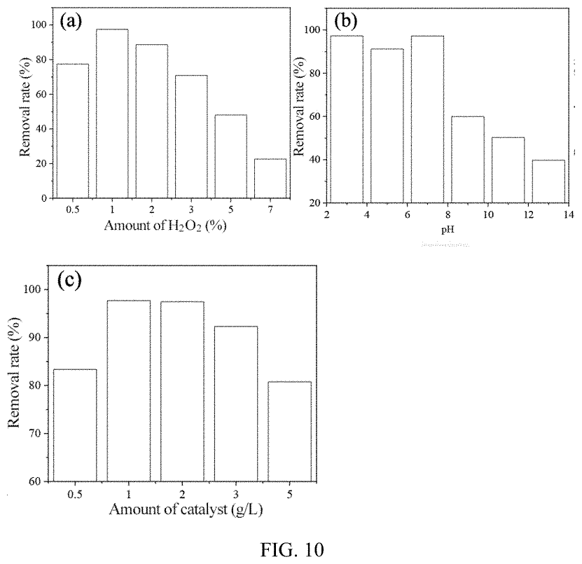

According to the experimental results regarding preparation conditions of the composite catalyst, the present disclosure studied effects of process conditions, such as pH, the amount of oxidant, and the amount of catalyst on the photodegradation performance in terms of sulfonamide containing waste water when using CBi-700-20% as the catalyst. The results are shown in FIG. 10.

FIG. 10 shows that the degradation rate of sulfonamide containing waste water is optimal when the water sample is acidic and neutral, so the pH value of the water sample is kept constant (pH=7). The degradation rate of sulfonamide containing waste water increases at first and decreases afterwards with a increasing amount of oxidant. Under the condition that the amount of H₂O₂ is 1%, an optimal degradation rate of sulfonamide is achieved. Under the condition that the amount of the catalyst is 1 g/L, an optimal degradation rate of sulfonamide is achieved, which may be up to 97% or more.

Through the above analysis, it could be known that:

1. XRD, SEM, TEM, EDS, and XPS show that the walnut shell biochar obtained by pyrolysis could be introduced into BiVO₄ by hydrothermal synthesis method in the present disclosure, and the prepared composite photocatalyst has a larger specific surface area and more uniform and finer morphological structure in comparison with BiVO₄; the CBi composite material has a monoclinic scheelite structure; it can be seen from UV-Vis-DRS that the CBi composite photocatalyst could be excited by a wider range of visible light; it can be seen from PL and electrochemistry tests that the biochar doped BiVO₄ makes it possible to effectively improve the separation efficiency of photo-generated electron-hole pairs in the CBi composite material and to effectively reduce the recombination rate of photo-generated electron-hole pairs, thereby extending the lifetime of photo-generated electron-hole pairs;

2. An optimal photocatalytic degradation efficiency is achieved by using the composite material CBi-700-20% obtained when setting a pyrolysis temperature of 700° C. and a doping amount of 20% during the preparation of the catalyst;

3. A removal rate of sulfanilamide containing waste water of not less than 97% is achieved by using the CBi-700-20% composite material under the conditions that the concentration of reactant is 15 mg/L, the pH value of the solution is 7, the amount of catalyst is 1 g/L, the amount of oxidant is 1%, and that the solution is irradiated with 350 W xenon lamp for 7 hours;

4. Repeated experiments of CBi-700-20% composite material proves that the composite material has great stability.

Although the present disclosure is described herein with reference to the illustrative embodiments of the present disclosure, the above-mentioned embodiments are only preferred embodiments of the present disclosure, and the embodiments of the present disclosure are not limited by the above-mentioned embodiments. It should be understood that those skilled in the art could design many other modifications and implementations, and these modifications and implementations will fall within the scope and spirit disclosed in the present disclosure.

What is claimed is:

1. A method for preparing a biochar-modified bismuth vanadate catalyst, comprising,
preparation of a biochar
washing a walnut shell with deionized water, drying the walnut shell to remove water on the surface of the walnut shell, crushing the dried walnut shell, and sieving through a 100-mesh sieve, to obtain walnut shell powder, immersing the walnut shell powder in a ZnCl₂ solution with a concentration of 1-3 mol/L for 24 hours, and removing a supernatant to obtain a remaining solid, drying the remaining solid in an oven at 105° C. for 24 hours to obtain a dried remaining solid; heating the dried remaining solid in a tube furnace under a nitrogen atmosphere to 700° C. at a rate of 5-10° C./min, controlling the temperature to be constant, starting counting the time, subjecting the dried remaining solid to a pyrolysis for 3 hours, and stopping the heating, to obtain a pyrolysis solid product; cooling the pyrolysis solid product to ambient temperature, taking the cooled pyrolysis solid product out of the tube furnace, crushing the cooled pyrolysis solid product and sieving through a 100-mesh sieve, to obtain pyrolysis solid product powder, mixing the pyrolysis solid product powder with an enough HNO₃ solution with a concentration of 0.5-1.5 mol/L to obtain a mixture; supersonically dispersing the mixture for 30 minutes, centrifuging the mixture, to obtain a crude solid product; washing the crude solid product with deionized water until the obtained washing liquid is neutral; finally, completely drying the crude solid product in a blast drying box at 60-90° C., to obtain a walnut-shell biochar; and
preparation of biochar-modified bismuth vanadate catalyst
dissolving a certain amount of P123 in concentrated nitric acid, adding ethanol with a volume of 10-30 times the volume of the added concentrated nitric acid, adding Bi(NO₃)₃.5H₂O while stirring in such an amount that a molar ratio of bismuth vanadate to P123 in the biochar-modified bismuth vanadate catalyst is in a range of 1:(0.01-0.05), adding NH₄VO₃ in an amount equimolar with that of Bi(NO₃)₃.5H₂O while vigorously stirring, to form a yellow precipitate, thereby obtaining a suspension, adding the walnut-shell biochar to the suspension in such amount that a mass percentage of biochar to BiVO₄ is 20%, and adjusting a pH value of the resulting mixture to 7 with NaOH and HNO₃; and
stirring the resulting mixture for 0.5-2 hours, and transferring the resulting mixture to a tetrafluoroethylene-lined stainless steel autoclave, keeping a total volume of the resulting mixture in the tetrafluoroethylene-lined stainless steel autoclave not less than ⅔ of the capacity of the autoclave, otherwise adding ethanol, placing the tetrafluoroethylene-lined stainless steel autoclave in a blast drying box, heating to 120° C. and maintaining at the temperature for 12 hours therein; cooling to ambient temperature naturally to obtain a yellow precipitate, washing the yellow precipitate with ethanol by centrifugation for 3-5 times, then washing with deionized water by centrifugation for 3-5 times, drying the precipitate in a blast drying box at 80° C. for 12 hours, to obtain a biochar-modified bismuth vanadate catalyst.

2. The method for preparing a biochar-modified bismuth vanadate catalyst as claimed in claim 1, wherein drying the walnut shell to remove water on the surface of the walnut shell comprises drying the walnut shell in an oven at 60-90° C. for 0.5-1 hour.

3. The method for preparing a biochar-modified bismuth vanadate catalyst as claimed in claim 1, wherein completely drying the crude solid product in a blast drying oven at 60-90° C. comprises drying the crude solid product for 2-5 hours.

4. A biochar-modified bismuth vanadate catalyst, as prepared by the method for preparing a biochar-modified bismuth vanadate catalyst as claimed in claim 1.

5. A method for treating sulfonamide containing waste water, comprising adding the biochar-modified bismuth vanadate catalyst as claimed in claim 4 into sulfonamide containing waste water.

6. The method for treating sulfonamide containing waste water as claimed in claim 5, wherein the biochar-modified bismuth vanadate catalyst is added in an amount of 50-100 times the mass of sulfonamide contained in the sulfonamide containing waste water.

7. The method for treating sulfonamide containing waste water as claimed in claim 6, further comprising adding H₂O₂ simultaneously when adding the biochar-modified bismuth vanadate catalyst, in an amount which accounts for 1% of the volume of the sulfonamide containing waste water, and meanwhile maintaining the resulting solution acidic or neutral, stirring for 30 minutes in the dark to be uniform, and exposing to natural light for 7 hours.

8. A method for preparing a biochar-modified bismuth vanadate catalyst, comprising,
forming walnut shell powder from a walnut shell;
immersing the walnut shell powder in a ZnCl2 solution for a predetermined time period;
removing a supernatant from the walnut shell powder in the ZnCl2 solution to obtain a solid;
drying the solid for a predetermined time period to obtain a dried solid;
heating the dried solid under a nitrogen atmosphere to a predetermined temperature;
subjecting the dried solid to a pyrolysis for a predetermined time to obtain a pyrolysis solid product;
cooling the pyrolysis solid product to ambient temperature;
forming a pyrolysis solid product powder from the pyrolysis solid product;
mixing the pyrolysis solid product powder with an HNO3 solution to obtain a mixture;
dispersing and centrifuging the mixture for a predetermined time period to obtain a crude solid product;
washing the crude solid product with deionized water;
drying the crude solid product at a predetermined temperature to obtain a walnut-shell biochar;
dissolving a certain amount of P123 in concentrated nitric acid;
adding ethanol, Bi(NO3)3.5H2O, and NH4VO3 to the P123 dissolved in the concentrated nitric acid while vigorously stirring, to form a first precipitate, thereby obtaining a suspension, wherein the ethanol is added so that it has a volume greater than a volume of the concentrated nitric acid, wherein the Bi(NO3)3.5H2O is added in an amount that a molar ratio of bismuth vanadate to P123 in the biochar-modified bismuth vanadate catalyst is in a range of 1:(0.01-0.05), and wherein the NH4VO3 is added in an amount equimolar with that of Bi(NO3)3.5H2O;
adding the walnut-shell biochar to the suspension in such amount that a mass percentage of biochar to BiVO4 is 20%, and adjusting a pH value of the resulting mixture to 7;
stirring the resulting mixture for a predetermined time period;
adding ethanol to the resulting mixture and heating the resulting mixture to a predetermined temperature for a predetermined time period;
cooling to ambient temperature to obtain a second precipitate;
washing the second precipitate with ethanol and deionized water; and
drying the precipitate at a predetermined temperature for a predetermined time to obtain a biochar-modified bismuth vanadate catalyst.
